(19) United States
(12) Patent Application Publication
(10) Pub. No.: US 2026/0141016 A1
(43) Pub. Date: May 21, 2026

(54) TARGET OPTIMIZATION DEVICE, METHOD AND PROGRAM

(71) Applicant: NTT, Inc., Tokyo (JP)

(72) Inventors: Yasunori Akagi, Musashino-shi, Tokyo (JP); Naoki MARUMO, Musashino-shi, Tokyo (JP); Takeshi KURASHIMA, Musashino-shi, Tokyo (JP)

(21) Appl. No.: 19/121,326

(22) PCT Filed: Nov. 2, 2022
(86) PCT No.: PCT/JP2022/041006

§ 371 Date: Apr. 15, 2025

(51) Int. Cl. G06F 17/11; G06F 17/40

(52) U.S. Cl. CPC G06F 17/11; G06F 17/40

(57) ABSTRACT

According to one aspect of the invention, when an optimal target of an action is calculated by using a model based on a graph configured with a plurality of vertices indicating a state represented by a degree of achievement of the action and a required time for the achievement of the action and a plurality of edges indicating the action that a person can take in the state, a reward for achieving the state, a maximum value of the required time, and a present bias parameter for weighting a cost for taking the action in a time series are acquired. The optimal target for the action is calculated by substituting the reward, the maximum value of the required time, and the present bias parameter into an optimal target calculation formula generated based on a simplified model in which a shape of the graph is restricted by reflecting a present bias.

### TECHNICAL FIELD

One aspect of the present invention relates to a target optimization device, method, and program for optimizing a target regarding a human action.

### BACKGROUND ART

For example, it is important to model human action when trying to achieve a certain target, such as reaching a step count target for dieting or completing a course of study in an online class. This is because such modeling can predict person's future actions and how those actions will change upon intervention, making it possible to determine appropriate interventions to help that person achieve their targets.

Incidentally, as one modeling technique, for example, Non Patent Literature 1 proposes a model based on graph theory. In this model, possible states that a human can take are represented as vertices, and possible actions that a human can take in each state are represented as edges. In addition, a cost is set for each edge, and this cost represents the effort, that is, load, involved in taking an action. Moreover, a reward is set for each vertex, which represents a reward for reaching a corresponding state.

On this graph, an agent evaluates its own gain for each possible trajectory of actions (paths on the graph) that the agent can take in the future, and selects to take an action with the greatest gain. The gains of a sequence of actions are calculated by giving less weighting to future costs and greater weighting to most recent costs, using a present bias called quasi-hyperbolic discounting.

This model has attracted attention as a model that can adequately explain a human action, including irrationality, and has been extended to a model including other biases and the like (see, for example, Non Patent Literature 2 or 3). These extended models make it possible to solve optimization problems such as reward optimization and target optimization.

### CITATION LIST

### Non Patent Literature

Non Patent Literature 1: Jon Kleinberg and Sigal Oren, “Time-inconsistent planning: a computational problem in behavioral economics.” In Proceedings of the 15th ACM Conference on Economics and Computation, pages 547-564, 2014.
Non Patent Literature 2: Jon Kleinberg, Sigal Oren, and Manish Raghavan. “Planning problems for sophisticated agents with present bias.” In Proceedings of the 17th ACM Conference on Economics and Computation, pages 343-360, 2016.
Non Patent Literature 3: Jon Kleinberg, Sigal Oren, and Manish Raghavan. “Planning with multiple biases.” In Proceedings of the 18th ACM Conference on Economics and Computation, pages 567-584, 2017.

### SUMMARY OF INVENTION

### Technical Problem

Although the above-mentioned model enables flexible modeling by being based on graph theory, analytical handling may be difficult due to its excessively high degree of freedom. For example, the existing models described above are not suitable for tasks with simple structures, such as tasks that involve individual actions to “improve a single numerical indicator”, such as completing a course of study in an online class or achieving a step count target over a certain period of time.

The present invention has been made in light of the above circumstances, and an object thereof is to provide a technology that makes it possible to calculate a user's optimal target under the influence of a present bias, thereby enabling maximization of the degree of task achievement for each individual.

### Solution to Problem

In order to solve the above problem, according to one aspect of the present invention, there is provided a target optimization device or method for calculating an optimal target of an action using a model based on a graph configured with a plurality of vertices and a plurality of edges connecting the vertices, in which the vertices indicate a state represented by a degree of achievement of the action and a required time for the achievement of the action, the edges indicate the action that a person can take in the state, a reward for achieving the state is set for the vertices, and a cost for taking the action is set for the edges, the target optimization device or method including: a first processing unit or process that acquires the reward, a maximum value of the required time, and a present bias parameter for weighting the cost in a time series; a second processing unit or process that calculates the optimal target; and a third processing unit or process that outputs the optimal target calculated by the second processing unit or process. Then, in the second processing unit or process, the optimal target for the action is calculated by substituting the reward, the maximum value of the required time, and the present bias parameter into an optimal target calculation formula generated on the basis of a simplified model in which a configuration of the graph is restricted by reflecting a present bias.

### Advantageous Effects of Invention

According to one aspect of the present invention, it is possible to calculate a user's optimal target under the influence of a present bias, thereby providing a technology that enables maximization of the degree of task achievement for each individual.

### BRIEF DESCRIPTION OF DRAWINGS

FIG. 1 is a block diagram illustrating an example of a hardware configuration of a target optimization device according to one embodiment of the present invention.

FIG. 2 is a block diagram illustrating an example of a software configuration of the target optimization device according to one embodiment of the present invention.

FIG. 3 is a flowchart illustrating an example of a processing procedure and processing details of a series of processing for calculating an optimal target executed by a control unit of the target optimization device illustrated in FIG. 2.

FIG. 4 is a diagram illustrating an example of input data stored in an input data storage unit illustrated in FIG. 3.

FIG. 5 is a diagram illustrating an example of an optimal target calculation value stored in an optimal target storage unit illustrated in FIG. 3.

### DESCRIPTION OF EMBODIMENTS

An embodiment of the present invention will be described below with reference to the drawings.

### One Embodiment

### (Overview)

A “present bias”, which involves overvaluing current gains and losses and undervaluing future gains and losses, has a significant impact on target achievement. Therefore, by implementing optimized interventions on the basis of modeling that takes this “present bias” into account, it is possible to achieve more effective interventions.

In one embodiment of the present invention, a new model is devised that simplifies the model proposed by Kleinberg and Oren et al. by restricting the shape of the graph to reflect the above-mentioned “present bias”, and the optimal target for each individual is calculated using this model. In this way, it is possible to maximize the degree of task achievement for each individual.

### Configuration Example

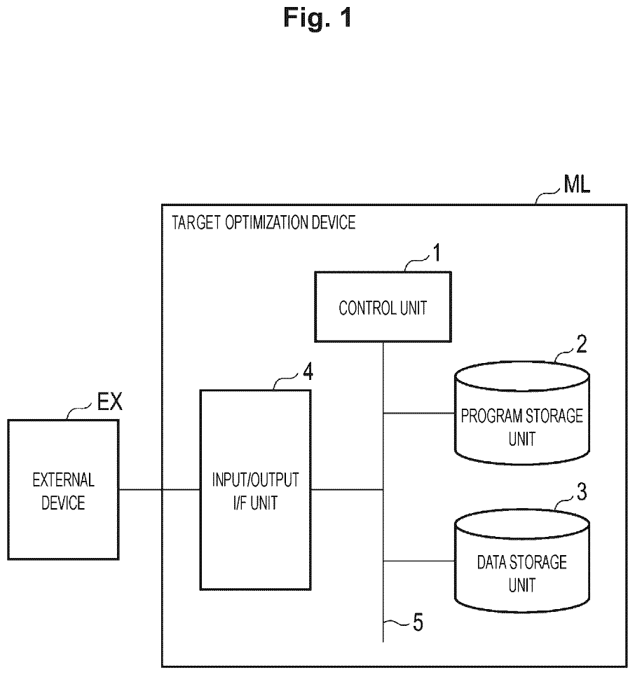

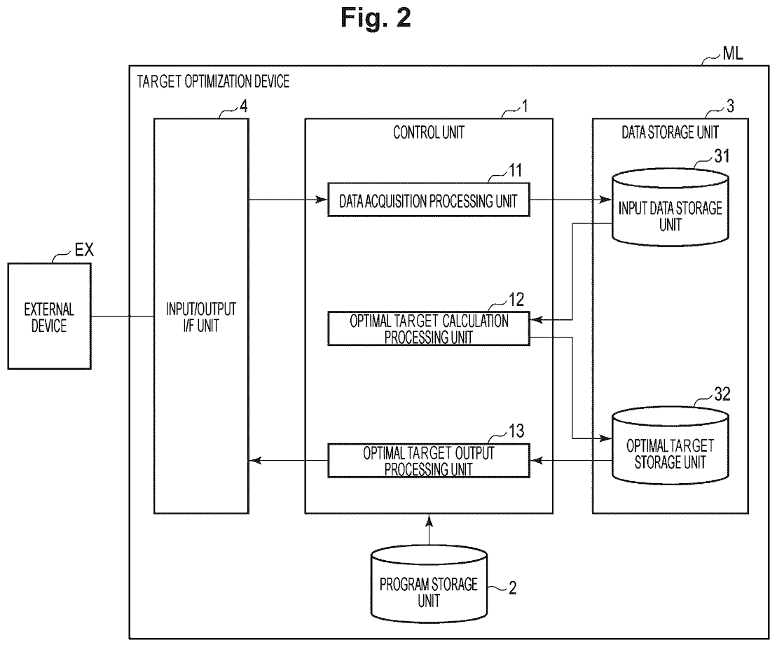

FIGS. 1 and 2 are block diagrams respectively illustrating examples of hardware and software configurations of a target optimization device according to one embodiment of the present invention.

A target optimization device ML is constituted by, for example, a server computer or a personal computer. The target optimization device ML includes a control unit 1 using hardware processors such as a central processing unit (CPU), and is configured by connecting a storage unit having a program storage unit 2 and a data storage unit 3, and an input/output interface (hereinafter, “interface” is abbreviated as “I/F”) unit 4 to the control unit 1 via a bus 5. The target optimization device ML may include a communication I/F unit for transmitting and receiving information data over a network or the like.

An external device EX used by an administrator or the like is connected to the input/output I/F unit 4 via a signal cable or a network. The input/output I/F unit 4 receives input data used for calculating the optimal target from the external device EX, and outputs the optimal target calculated by the control unit 1 to the external device EX.

The program storage unit 2 is configured, for example, by combining a non-volatile memory such as a hard disk drive (HDD) or a solid state drive (SSD) that can be written to and read from at any time and a non-volatile memory such as a read only memory (ROM) serving as storage media, and stores various programs necessary for executing various kinds of control processing according to one embodiment of the present invention in addition to middleware such as an operating system (OS).

The data storage unit 3 is configured, for example, by combining a non-volatile memory such as an HDD or an SSD that can be written to and read from at any time and a volatile memory such as a random access memory (RAM) serving as storage media, and includes an input data storage unit 31 and an optimal target storage unit 32 as storage areas necessary for implementing one embodiment of the present invention.

The input data storage unit 31 is used to store input data, which is input from the external device EX and serves as a condition for calculating an optimal target. The optimal target storage unit 32 is used to store the optimal target value calculated by the control unit 1.

The control unit 1 includes a data acquisition processing unit 11, an optimal target calculation processing unit 12, and an optimal target output processing unit 13 as processing functions according to one embodiment of the present invention.

These processing units 11 to 13 are all implemented by causing the hardware processor of the control unit 1 to execute application programs stored in the program storage unit 2. Incidentally, some or all of the processing units 11 to 13 may be implemented using hardware such as a large scale integration (LSI) or an application specific integrated circuit (ASIC).

Furthermore, each of the above application programs does not need to be stored in advance in the program storage unit 2, and may be downloaded from an external device EX or other server device when necessary and stored in the program storage unit 2, for example.

The data acquisition processing unit 11 takes in data input in the external device EX via the input/output I/F unit 4. Then, the taken-in data is stored in the input data storage unit 31. The input data includes the reward, the maximum number of days, and a parameter representing the strength of the present bias.

The optimal target calculation processing unit 12 reads the reward, the maximum number of days, and the present bias parameter from the input data storage unit 31. The read input data is then substituted as conditions into a previously prepared formula for calculating the optimal target, and calculations are performed to calculate the optimal target. The optimal target calculation processing unit 12 stores the calculation result of the optimal target in the optimal target storage unit 32.

The optimal target output processing unit 13 reads out the optimal target from the optimal target storage unit 32, and outputs information indicating the read optimal target from the input/output I/F unit 4 to the external device EX.

### Operation Example

Next, an operation example of the target optimization device ML configured as described above will be described.

### (1) Model Used in One Embodiment

The model used in one embodiment is a simplification of the model by Kleinberg and Oren et al. by restricting the shape of the graph by taking into account a “present bias” as described above.

Now, the vertex set and the edge set of the graph are defined as follows.

$$V = \{ ( i , x ) \vert i ∈ \{ 0 , … , N \} , x \geq 0 \}$$

$$E = \{ ( ( i , x ) , ( i + 1 , y ) ) \vert i ∈ \{ 0 , … , N - 1 \} , x , y \geq 0 \}$$

Here, i is a discrete value, and x is a continuous value. In addition, the cost of the edge ((i, x), (i+1, y)) is set to (y−x)², and the reward obtained at the vertex (i, x) is set to r(i, x).

At the vertex (i, x), i corresponds to a numerical indicator representing the time, and x corresponds to a numerical indicator representing the degree of progress of the task.

For example, in a case where a task of “walking 100,000 steps in 30 days” is now considered, i represents the current day, and x represents the number of steps walked so far. N is the maximum number of days, which in this example corresponds to “30 days”.

In this way, the model according to one embodiment restricts the shape of the graph by reflecting the time conditions, which enables the analytical handling described below. This is different from the model of Kleinberg and Oren et al.

Here, a≥0, R>0, and the reward is defined as r(N, x)=R1[x≥a]. Also, for i<N, r(i, x)=0. This corresponds to “giving a reward R in a case where the agent achieves the degree of progress of a task of a or more by time N”. That is, a is the agent's target, and R corresponds to the reward.

Hereinafter, if x≤a, the objective cost c(i, x) in the case of starting from the vertex (i, x) is determined by the following formula.

$$\begin{matrix}c ( i , x ) := min \{ 0 , {min}_{{y}_{i + 1} , … , {y}_{N}} \{ {\sum }_{j = i + 1}^{N} {( {y}_{j} - {y}_{j - 1} )}^{2} \vert {y}_{N} \geq a \} \} \\ = min \{ 0 , ( N - i ) {( \frac{a - x}{N - i} )}^{2} - R \}\end{matrix} \qquad [ Math . 1 ]$$

In addition, if paths which are actually followed (subjectively optimal paths) are (0, z0), (1, z1), . . . , and (N, zN), (zi) representing a destination point is determined by the following formula.

$${z}_{0} = 0 , \qquad [ Math . 2 ]$$

$${z}_{i} = {arg min}_{x ∈ R} \{ \frac{1}{β} {( x - {z}_{i - 1} )}^{2} + c ( i , x ) \} , i ∈ \{ 1 , 2 , … , N \}$$

Here, β is a parameter that represents the strength of the present bias, in particular the strength of the quasi-hyperbolicity, and satisfies 0≤β≤1. A small β will result in an agent that places particularly heavy weight on a most recent cost, whereas a large β will result in an agent that also evaluates future costs.

Summarizing this, the following formula can be seen.

$$\begin{matrix}[ Math . 3 ] & \\ {z}_{i} = \{ \begin{matrix}a + \frac{N - i}{N - u + β} ( {z}_{i - 1} - a ) & if - \sqrt{R ( N - i + β )} \leq {z}_{i - 1} - a , \\ {z}_{i - 1} & otherwise\end{matrix} & ( 1 )\end{matrix}$$

That is,

−√(R(N−i+β))≤zi−1−a
in the above case, the reward is aimed, but

zi−1−a<-√(R(N−i+β))
in the above case, the reward is given up.

From Formula (1), once the reward is given up, the reward is not aimed at again. That is, if zi−1=zi, it can be seen that zi−1=zi= . . . . =zN.

Thus, when the following formula is set,

$${p}_{i} := \frac{N - i}{N - i + β} \qquad [ Math . 4 ]$$

there exists k≥0 such that the following formula is defined.

$${z}_{i} = \{ \begin{matrix}a + {p}_{i} ( {z}_{i - 1} - a ) & if 1 \leq i \leq k , \\ {z}_{i - 1} & if i > k\end{matrix} \qquad [ Math . 5 ]$$

In this case,

$${z}_{N} = a ( 1 - {\prod }_{i = 1}^{k} {p}_{i} ) \qquad [ Math . 6 ]$$

the above formula is defined, and

$$- \sqrt{R ( N - j - 1 + β )} > a ( 1 - {\prod }_{i = 1}^{k} {p}_{i} ) - a \qquad [ Math . 7 ]$$

k is the smallest 0≤j<N that satisfies the above condition. However, if the above condition does not hold for all 0≤j<N, then k=N.

Summarizing the above conditions,

$$\frac{1}{N - j - 1 + β} {\prod }_{i = 1}^{j} {p}_{i}^{2} > \frac{R}{{a}^{2}} \qquad [ Math . 8 ]$$

the above formula is defined.

Subsequently,

$${q}_{i} := \frac{1}{N - i - 1 + β} {\prod }_{i = 1}^{ι} {p}_{i}^{2} \qquad [ Math . 9 ]$$

the above formula is set and the shape of qi is examined. First,

$$\frac{{q}_{i}}{{q}_{i - 1}} = \frac{N - i + β}{N - i - 1 + β} {p}_{i}^{2} = \frac{{( N - i )}^{2}}{( N - i + β ) ( N - i - 1 + β )} \qquad [ Math . 10 ]$$

the above formula is defined. Accordingly,

$$N = \frac{β ( 1 - β )}{2 β - 1} < i \qquad [ Math . 11 ]$$

it can be seen that the range of i for which qi>qi−1 is satisfied is expressed as the above formula when β>½.

On the other hand, when β≤½, qi>qi−1 is satisfied for any i. From this, the following can be seen.

First, in a case where β>½, and

$$\frac{β ( 1 - β )}{2 β - 1} < 1 \qquad [ Math . 12 ]$$

the above formula is defined, β>(√5−1)/2=0.618 . . . means that qi is monotonically decreasing with i. In other words, in a case where β is large enough (foresighted), the reward can be given up at time i=0.

Next, in a case where there exists a threshold value ½<β0≤(√5−1)/2 and

$${arg max}_{0 \leq i < N} {q}_{i} = \{ \begin{matrix}N - 1 & if β < {β}_{0} , \\ \{ 0 , N - 1 \} & if β = {β}_{0} , \\ 0 & if β > {β}_{0} ,\end{matrix} \qquad [ Math . 13 ]$$

the above condition is defined,

$${max}_{0 \leq i < N} {q}_{i} = max \{ {q}_{0} , {q}_{N - 1} \} \qquad [ Math . 14 ]$$

the above formula is satisfied.

Furthermore, in a case of β<β0, the time to give up varies within the range 0≤i≤N−2 depending on the target a and the reward R.

### (2) Calculation Operation of Optimal Target

The target optimization device ML calculates the optimal target as follows.

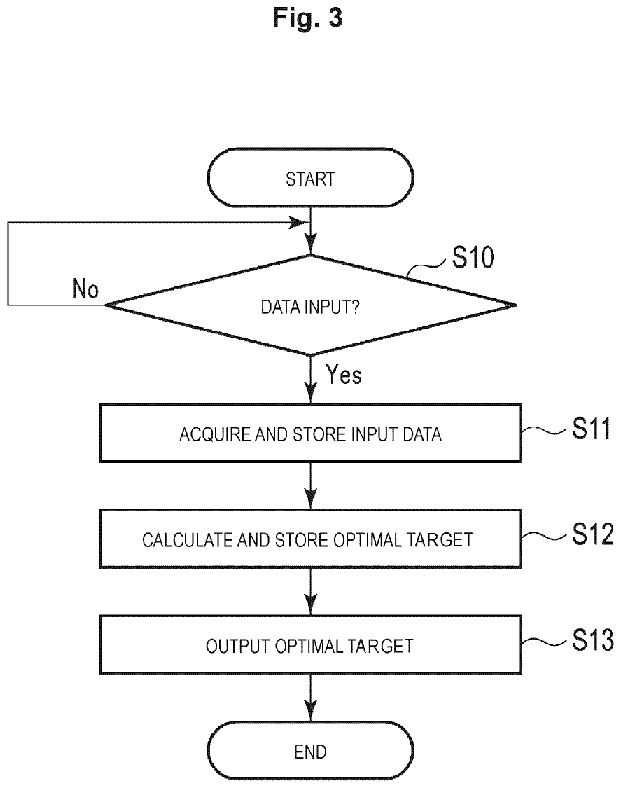

FIG. 3 is a flowchart illustrating an example of a series of processing procedures and processing details for calculating the optimal target executed by the control unit 1 of the target optimization device ML.

### (2-1) Acquisition of Input Data

For example, in a case where a certain subject tries to obtain the optimal target of the number of steps for dieting, the subject inputs a reward R, the number of time steps (for example, the maximum number of days) N, and a present bias parameter β in the external device EX. The external device EX transmits the input reward R, the maximum number of days N, and the present bias parameter β to the target optimization device ML together with a data input request.

In response to this, when receiving the data input request in step S10, the control unit 1 of the target optimization device ML receives the input data transmitted from the external device EX via the input/output I/F unit 4 in step S11 under the control of the data acquisition processing unit 11. Then, the received input data is stored in the input data storage unit 31.

### (2-2) Calculation of Optimal Target

When receiving the calculation request of the optimal target from the external device EX after acquiring the input data, the control unit 1 of the target optimization device ML executes the calculation processing of the optimal target a in step S12 as follows under the control of the optimal target calculation processing unit 12.

### (2-2-1) Mechanism for Optimization

First, a mechanism for optimization of the target a will be described.

The optimization problem is expressed as the following formula,

$${max}_{a \geq 0} {z}_{N} \qquad [ Math . 15 ]$$

and the solution to this formula is as follows.

That is, if the reward is given up at time 0, the destination point zN at the maximum number of days N becomes zN=0. In order not to give up the reward at time 0, it is required that the following formula:

$${q}_{0} \leq \frac{R}{{a}^{2}} \qquad [ Math . 16 ]$$

is satisfied, that is, the following formula:

$$a \leq \sqrt{R ( N - 1 + β )} \qquad [ Math . 17 ]$$

is satisfied. Hereinafter, it is assumed that the target a satisfies this condition.

In a case where the present bias parameter is β≥β0, zN=a is obtained unless the reward is given up at time 0, and thus it is preferable to set the target a as large as possible within a range satisfying the above condition. That is, if β≥0, it is optimal to set as follows.

$$a = \sqrt{R ( N - 1 + β )} \qquad [ Math . 18 ]$$

In this case, it is possible to find the optimal target a in a time complexity O(1).

Hereinafter, a case where β<β0 is satisfied is considered. The time k>0 at which the reward R is given up is fixed. In this case, the following formula holds.

$${q}_{k - 1} \leq \frac{R}{{a}^{2}} < {q}_{k} \qquad [ Math . 19 ]$$

It is preferable to set the target a as large as possible within the range that satisfies this condition. That is,

$$a = \sqrt{\frac{R}{{q}_{k - 1}}} \qquad [ Math . 20 ]$$

the above formula is preferable, and the destination point zN in this case is expressed as the following formula.

$$\begin{matrix}{z}_{N} = \sqrt{\frac{R}{{q}_{k - 1}}} ( 1 - {\prod }_{i = 1}^{k} {p}_{i} ) \\ = \sqrt{R ( N - k + β )} ( {\prod }_{i = 1}^{k - 1} \frac{1}{{p}_{i}} - {p}_{k} )\end{matrix} \qquad [ Math . 21 ]$$

Finally, by moving k, the optimization problem is expressed as the following formula.

$${max}_{a \geq 0} {z}_{N} = {max}_{0 < k \leq N} \sqrt{R ( N - k + β )} ( {\prod }_{i = 1}^{k - 1} \frac{1}{{p}_{i}} - {p}_{k} ) \qquad [ Math . 22 ]$$

By exhaustively searching k according to this formula, it is possible to find the optimal target a in a time complexity O(N).

Furthermore, in a case where the maximum number of days N is sufficiently large, it is possible to perform high-speed optimization by performing asymptotic analysis. That is, from the following formula:

$${\prod }_{i = 1}^{k - 1} \frac{1}{{p}_{i}} = {\prod }_{i = 1}^{k - 1} \frac{N - i + β}{N - i} = \frac{Γ ( N - k + 1 ) Γ ( N + β )}{Γ ( N ) Γ ( N - k + 1 + β )} \qquad [ Math . 23 ]$$

it can be written as follows.

$${v}_{k} = \sqrt{N - k + β} ( \frac{Γ ( N + β )}{Γ ( N )} \frac{Γ ( N - k + 1 )}{Γ ( N - k + 1 + β )} - \frac{N - k}{N - k + β} ) \qquad [ Math . 24 ]$$

Now, if N, N−k>>1, from the evaluation formula for the ratio of the gamma function represented by the following formula,

$$\frac{Γ ( N )}{Γ ( N + {β}_{0} )} = \frac{1}{{N}^{{β}_{0}}} ( 1 + O ( {N}^{- 1} ) ) . \qquad [ Math . 25 ]$$

the above vk is expressed as the following formula.

$$\begin{matrix}{v}_{k} ≃ \sqrt{N - k + β} ( {{N}^{β} ( N - k + 1 )}^{- β} - \frac{N - k}{N - k + β} ) \\ ≃ \sqrt{N - k} ( {( \frac{N}{N - k} )}^{β} - 1 ) \\ = \sqrt{N} \sqrt{\frac{N - k}{N}} ( {( \frac{N}{N - k} )}^{β} - 1 )\end{matrix} \qquad [ Math . 26 ]$$

The maximum value is obtained when the following Formula (2) is satisfied.

$$\begin{matrix}[ Math . 27 ] & \\ 1 - \frac{k}{N} = {( 1 - 2 β )}^{1 / β} & ( 2 )\end{matrix}$$

When the above approximation and Formula (2) hold, vk is expressed as follows:

$$\begin{matrix}{v}_{k} ≃ \sqrt{N} {( 1 - 2 β )}^{\frac{1}{2 β}} ( {( 1 - 2 β )}^{- 1} - 1 ) \\ = 2 {β ( 1 - 2 β )}^{\frac{1}{2 β} - 1} \sqrt{N}\end{matrix} \qquad [ Math . 28 ]$$

and the optimization problem is expressed as the following formula.

$${max}_{a \geq 0} {z}_{N} ≃ 2 {β ( 1 - 2 β )}^{\frac{1}{2 β} - 1} \sqrt{NR} \qquad [ Math . 29 ]$$

In addition, the optimal solution a* is expressed as follows.

$$\begin{matrix}{a}^{*} ≃ \sqrt{\frac{R}{{q}_{k - 1}}} \\ ≃ \sqrt{NR} \sqrt{\frac{N - k}{N}} {( \frac{N}{N - k} )}^{β} \\ ≃ {( 1 - 2 β )}^{\frac{1}{2 β} - 1} \sqrt{NR}\end{matrix} \qquad [ Math . 30 ]$$

According to this formula, the optimal target a can be found by the time complexity O(1).

### (2-2-2) Calculation of Optimal Target a

In step S12, the optimal target calculation processing unit 12 reads the reward R, the number of time steps (maximum number of days) N, and the present bias parameter β from the input data storage unit 31. Then, the optimal target a is calculated by substituting the above-read reward R, maximum number of days N, and present bias parameter β into the calculation formula of the above-optimal solution a*. Then, the optimal target calculation processing unit 12 stores the calculated optimal target a in the optimal target storage unit 32.

### (2-2-3) Specific Calculation Example

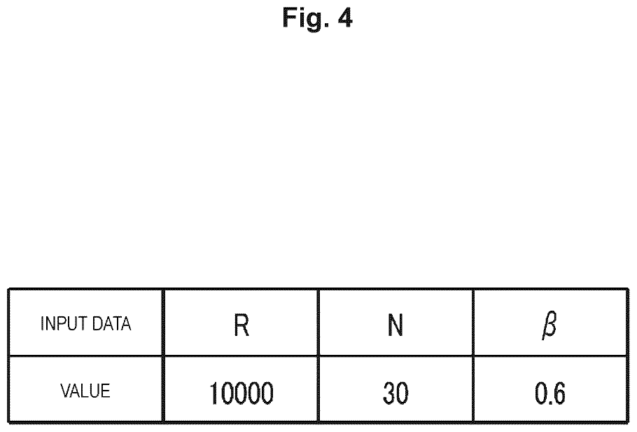

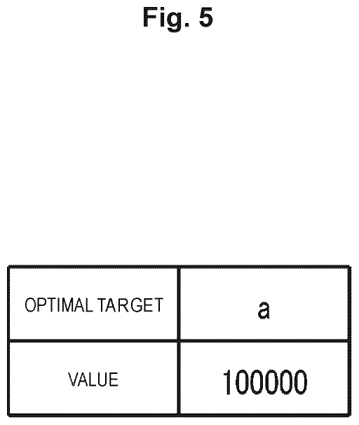

For example, it is assumed that the user now designates and inputs the reward R=10,000, the maximum number of days N=30, and the present bias parameter β=0.6 illustrated in FIG. 4 in the external device EX. In this case, the optimal target calculation processing unit 12 of the target optimization device ML calculates a=100,000 steps as the optimal target a, and this calculated value is stored in the optimal target storage unit 32 as illustrated in FIG. 5.

### (3) Output of Optimal Target a

The target optimization device ML reads out the calculation result of the optimal target a from the optimal target storage unit 32 in step S13 under the control of the optimal target output processing unit 13 in response to the output request of the calculation result from the external device EX. Then, the optimal target output processing unit 13 generates information for presenting the read calculation result of the optimal target a to the user, and transmits the generated presentation information from the input/output I/F unit 4 to the external device EX as a request source.

### (Operations and Effects)

As described above, in one embodiment, a model obtained by simplifying the model of Kleinberg and Oren et al. by reflecting the “present bias” and restricting the shape of the graph is prepared, and a calculation formula of the optimal target is generated by analyzing the simplified model. Then, the reward R, the number of time steps (maximum number of days) N, and the present bias parameter β are acquired as input data from the external device EX, and the acquired reward R, number of time steps (maximum number of days) N, and present bias parameter β are substituted into the calculation formula of the optimal target to calculate the optimal target a, and the optimal target a is output to the external device EX.

Accordingly, it is possible to calculate the user's optimal target a under the influence of a present bias, thereby maximizing the degree of task achievement for each individual.

### Other Embodiments

(1) In the above embodiment, a case where a model that enables analytical handling by restricting the shape of the graph is generated in advance in another device, such as an external device EX has been described as an example. However, the model generation processing function may be provided in the target optimization device ML.
(2) In the above embodiment, a case where the target optimization device ML is provided independently of the external device EX has been described as an example. However, the present invention is not limited thereto, and each function of the target optimization device ML may be provided in the external device EX. Accordingly, the external device EX can collectively perform all processes including the optimal target calculation processing, for example.
(3) In addition, the functional configuration of the target optimization device, the processing procedures and processing details of the optimal target calculation processing, the type of action for which the optimal target is calculated, and the like can be variously modified and implemented without departing from the gist of the present invention.

Although the embodiments of the present invention have been described in detail above, the above description is merely illustrative of the present invention in every respect. It goes without saying that various modifications and variations can be made without departing from the scope of the present invention. That is, a specific configuration according to the embodiment may be appropriately employed in implementing the present invention.

The present invention is not limited to the embodiment as it is but can be embodied by modifying components in the practical phase without departing from the gist thereof. Further, various inventions can be formed by appropriate combinations of the plurality of components disclosed in the above embodiments. For example, some components of all the components shown in the embodiment may be omitted. Further, constituent elements in different embodiments may be appropriately combined.

### REFERENCE SIGNS LIST

ML Target optimization device
EX External device
1 Control unit
2 Program storage unit
3 Data storage unit
4 Input/output I/F unit
5 Bus
11 Data acquisition processing unit
12 Optimal target calculation processing unit
13 Optimal target output processing unit
31 Input data storage unit
32 Optimal target storage unit

1. A target optimization device comprising processing circuitry configured to:
acquire input data that respectively designates a reward for achieving a state, a maximum value of a required time for achievement of an action, and a present bias parameter for weighting a cost in a time series, the state being represented by a degree of the achievement of the action and the required time, the cost being for taking the action;
calculate an optimal target of the action using a model based on a graph configured with a plurality of vertices and a plurality of edges connecting the vertices, the vertices indicating the state, the edges indicating the action that a person can take in the state, the reward being set for the vertices, and the cost being set for the edges; and
output the optimal target calculated,
wherein the processing circuitry is configured to calculate the optimal target for the action by substituting the reward, the maximum value of the required time, and the present bias parameter into an optimal target calculation formula generated on a basis of a simplified model in which a shape of the graph is restricted by reflecting a present bias.

2. The target optimization device according to claim 1, wherein the processing circuitry is configured to calculate the optimal target by using a formula for calculating an optimal solution a* as in a following formula as the optimal target calculation formula:
$$\begin{matrix}{a}^{*} ≃ \sqrt{\frac{R}{{q}_{k - 1}}} \\ ≃ \sqrt{NR} \sqrt{\frac{N - k}{N}} {( \frac{N}{N - k} )}^{β} \\ ≃ {( 1 - 2 β )}^{\frac{1}{2 β} - 1} \sqrt{NR}\end{matrix}$$
where R is the reward, N is the maximum value of the required time, and β is the present bias parameter.

3. The target optimization device according to claim 1, wherein the present bias parameter is set to a first value in a case where emphasis is placed on a most recent cost, and is set to a second value greater than the first value in a case where emphasis is placed on a future cost.

4. A target optimization method comprising:
acquiring input data that respectively designates a reward for achieving a state, a maximum value of a required time for achievement of an action, and a present bias parameter for weighting a cost in a time series, the state being represented by a degree of the achievement of the action and the required time, the cost being for taking the action;
calculating an optimal target of the action using a model based on a graph configured with a plurality of vertices and a plurality of edges connecting the vertices, the vertices indicating the state, the edges indicating the action that a person can take in the state, the reward being set for the vertices, and the cost being set for the edges; and
outputting the optimal target calculated,
wherein the calculating the optimal target includes calculating the optimal target for the action by substituting the reward, the maximum value of the required time, and the present bias parameter into an optimal target calculation formula generated on a basis of a simplified model in which a shape of the graph is restricted by reflecting a present bias.

5. A non-transitory computer-readable storage medium configured with instructions executable by one or more processors included in a target optimization device to cause the one or more processors to perform operations comprising:
acquiring input data that respectively designates a reward for achieving a state, a maximum value of a required time for achievement of an action, and a present bias parameter for weighting a cost in a time series, the state being represented by a degree of the achievement of the action and the required time, the cost being for taking the action;
calculating an optimal target of the action using a model based on a graph configured with a plurality of vertices and a plurality of edges connecting the vertices, the vertices indicating the state, the edges indicating the action that a person can take in the state, the reward being set for the vertices, and the cost being set for the edges; and
outputting the optimal target calculated,
wherein the calculating the optimal target includes calculating the optimal target for the action by substituting the reward, the maximum value of the required time, and the present bias parameter into an optimal target calculation formula generated on a basis of a simplified model in which a shape of the graph is restricted by reflecting a present bias.

6. The non-transitory computer-readable storage medium according to claim 5, wherein the calculating an optimal target calculates the optimal target by using a formula for calculating an optimal solution a* as in a following formula as the optimal target calculation formula:
$$\begin{matrix}{a}^{*} ≃ \sqrt{\frac{R}{{q}_{k - 1}}} \\ ≃ \sqrt{NR} \sqrt{\frac{N - k}{N}} {( \frac{N}{N - k} )}^{β} \\ ≃ {( 1 - 2 β )}^{\frac{1}{2 β} - 1} \sqrt{NR}\end{matrix}$$
where R is the reward, N is the maximum value of the required time, and β is the present bias parameter.

7. The non-transitory computer-readable storage medium according to claim 5, wherein the present bias parameter is set to a first value in a case where emphasis is placed on a most recent cost, and is set to a second value greater than the first value in a case where emphasis is placed on a future cost.
